(19) United States
(12) Patent Application Publication
(10) Pub. No.: US 2019/0277002 A1
(43) Pub. Date: Sep. 12, 2019

(54) SYSTEM AND METHOD FOR SELECTING PROPER COMPONENTS FOR MITIGATING RADON

(71) Applicant: Systemair Mfg. Inc., Lenexa, KS (US)

(72) Inventors: Hamid Massali, Leawood, KS (US); Ethan O'Loughlin, Columbus, OH (US)

(73) Assignee: Systemair Mfg. Inc., Lenexa, KS (US)

(21) Appl. No.: 15/916,429

(22) Filed: Mar. 9, 2018

(51) Int. Cl. E02D 31/00; F24F 7/06

(52) U.S. Cl. CPC E02D 31/008; G06F 2217/08; F24F 7/065

(57) ABSTRACT

A system and method for selecting a proper fan for an air flow system for mitigating radon in a building. An air flow system includes a pipe connected to an access hole extending through the center of a slab and into the underlying soil. A test hole also extends through the slab. A variable speed test fan is installed in the pipe, and a manometer is installed to measure a static pressure value of the overall system. A chart or a computer program is configured to correlate a particular speed of the test fan and a particular static pressure value when the test fan creates an initial draw at the test hole with an identification of a proper fan. The proper fan has an operating speed which is closest to the particular speed. The proper fan is then installed in place of the test fan in the air flow system.

### FIELD

The present invention relates to systems and methods for mitigating radon, and more particularly, embodiments concern a system and method for selecting proper components, particularly a proper fan, for mitigating the presence of radon gas in a building or other structure.

### BACKGROUND

Radon is a naturally occurring radioactive, colorless, odorless, and tasteless gas. Radon is a health hazard and is often the single largest contributor to individuals' background radiation dose, and breathing high concentrations of radon has been linked to lung cancer. Due to local differences in geology, the hazard of radon varies from location to location. Radon can accumulate in buildings, where because of its relatively high density, it generally accumulates in lower areas such as basements and crawl spaces. Thus, it is often desirable to detect and mitigate the presence of radon.

One method of mitigating radon in a residential building is to depressurize a foundation slab of the building using an inline fan and polyvinyl chloride (PVC) pipes for ducting. However, because soil conditions and building sizes vary, determining the exact negative pressure required for a particular job can be difficult. Currently, radon mitigators rely on rough estimates of areas and past experience to size their systems, but it is not uncommon for mitigators to have to return to jobs, sometimes more than once, and upgrade the fans to meet the static pressure requirements through a process of trial and error. Some mitigators initially install oversized fans so that they do not have to return to jobs, but this unnecessarily increases cost and power consumption.

This background discussion is intended to provide information related to the present invention which is not necessarily prior art.

### SUMMARY

Embodiments address the above-described and other problems by providing a system and method for selecting proper components, particularly a proper fan, for mitigating the presence of radon gas in a building or other structure.

In a first embodiment, a system is provided for facilitating the selection of a proper fan for an air flow system for mitigating radon in a particular structure. The particular structure may broadly have a foundation slab and the airflow system. The air flow system may include a lower pipe in communication with an access hole extending through an approximate center of the foundation slab and into a soil beneath the foundation slab; an upper pipe connecting the lower pipe to an exterior area above the particular structure; and a test hole extending through the foundation slab at a location which is spaced apart from the access hole. The system may broadly comprise a test fan, a manometer, and a visual tool and/or a computer program. The test fan may be installed along the pipe assembly, wherein the test fan may be a variable speed fan having a known performance curve. The manometer may be configured to measure a static pressure value as a pressure differential across the test fan.

The visual tool may be configured to correlate a particular speed of the test fan and a particular static pressure value when operation of the test fan creates an initial draw of air due to a negative pressure under the foundation slab at the test hole with an identification of a proper fan from among a plurality of possible fans. The proper fan may have an operating speed which is closest to the particular speed, and may be installed in place of the test fan in the air flow system for mitigating radon in the particular structure.

The computer program may be executed on a mobile computing device and configured to receive as input the particular speed of the test fan and the particular static pressure when operation of the test fan creates the initial draw of air due to negative pressure under the foundation slab at the test hole; identify the proper fan from among the plurality of possible fans based on the input, wherein the proper fan has the operating speed which is closest to the particular speed; and output the identification of the proper fan to be installed in place of the test fan in the air flow system for mitigating radon in the particular structure.

Various implementations of the first embodiment may include any one or more of the following features. The visual tool may include first data representing behavior of the test fan operating at different speeds, and second data representing behavior of an overall system resulting in different static pressure values, wherein an intersection of the first data and the second data provides a basis for identifying the proper fan from among the plurality of possible fans. The visual tool may be a chart, and the first data may be presented as a first plotted line, and the second data may be presented as a second plotted line. The proper fan may be operable to run only at the operating speed, or the proper fan may be operable to run at two or more speeds including the operating speed. The mobile computing device may be a mobile laptop or tablet computer, or a smartphone.

In a second embodiment, a method is provided for facilitating the selection of a proper fan for mitigating radon in a particular structure having a foundation slab. The method may broadly comprise the following. An air flow system may be installed including a pipe assembly including a lower pipe in communication with an access hole extending through an approximate center of the foundation slab and into a soil beneath the structure, and an upper pipe connecting the lower pipe to an exterior area above the particular structure. A test hole may be created extending through the foundation slab at a location which is spaced apart from the access hole. A test fan may be installed along the pipe assembly, wherein the test fan is a variable speed fan having a known performance curve. A manometer may be installed configured to measure a static pressure value as a pressure differential across the test fan. A computer program may be executed on a mobile computing device and configured to receive as input a particular speed of the test fan and a particular static pressure value when operation of the test fan creates an initial draw of air due to negative pressure under the foundation slab at the test hole; identify a proper fan from among a plurality of possible fans based on the input, wherein the proper fan has an operating speed which is closest to the particular speed; and output an identification of the proper fan. The test fan may be removed and the proper fan may be installed in the pipe assembly for mitigating radon in the particular structure.

Various implementations of the second embodiment may include any one or more of the following features. The mobile computing device may be a mobile laptop or tablet computer, or a smartphone. The proper fan may be operable to run only at the operating speed, or the proper fan may be operable to run at two or more speeds including the operating speed.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a perspective view of an exemplary air flow system installed in an exemplary particular structure (shown in broken line) for mitigating the presence of radon gas in the structure;

FIG. 2 is a perspective view of components of a system for selecting a proper fan for the air flow system of FIG. 1;

FIG. 3 is a first example working point chart of static pressure versus flow rate for a test fan operating at maximum speed and the examplary structure, which can be used to identify a working point required for the proper fan;

FIG. 4 is a second example working point chart of static pressure versus flow rate for the test fan operating at different speeds and different overall systems, which can be used to identify a working point required for the proper fan;

FIG. 5 is an example fan selection chart showing static pressure versus flow rate for several different fans, which is used to select the proper fan component for the system based on a working point from FIG. 3 or 4; and

FIG. 6 is a flowchart of steps involved in a method for selecting a proper fan for the exemplary air flow system of FIG. 1 using the system of FIG. 2.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, embodiments concern a system and method for selecting proper components, particularly a proper fan, for mitigating the presence of radon gas in a building or other structure. Embodiments advantageously match the fan component to the particular requirements of a particular job, thereby eliminating the temptation to install a fan that is too large for the job, which saves money, while also eliminating the need to return to the particular job in order to upgrade a fan that is too small, which saves both time and money.

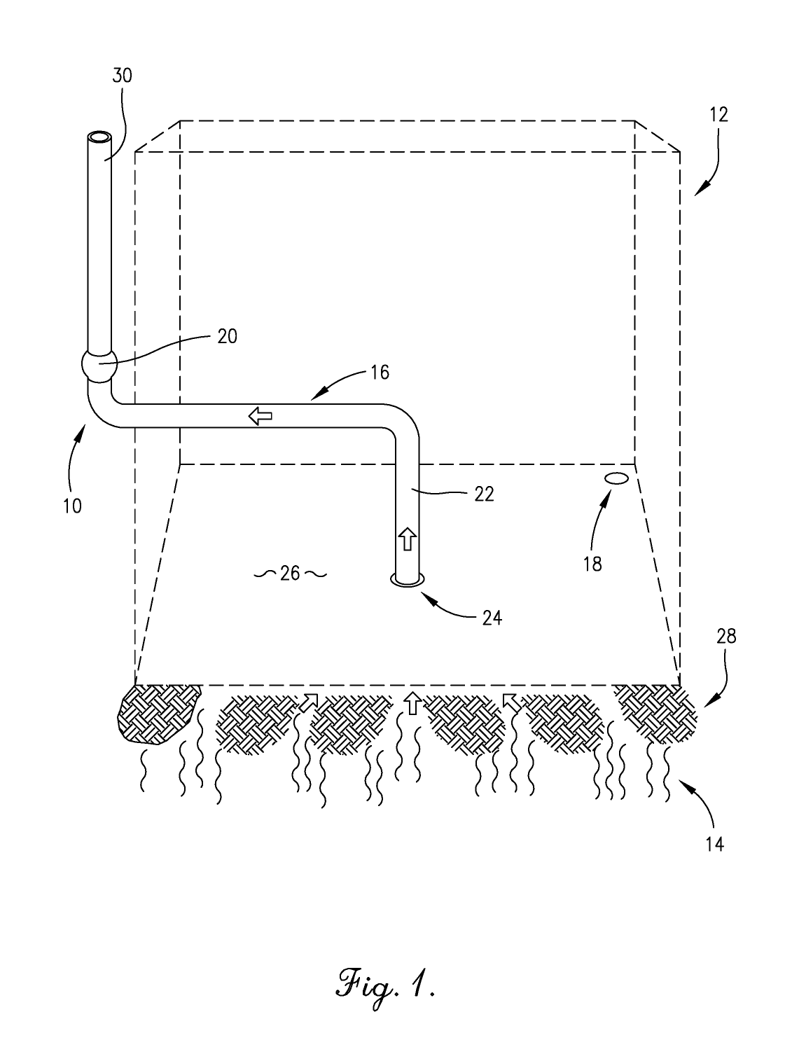

Referring to FIG. 1, an exemplary air flow system 10 is shown installed in an exemplary particular structure 12 (shown in broken line) for mitigating the presence of radon gas 14 in the structure 12. The air flow system 10 may include a pipe assembly 16, a test hole 18, and a proper fan 20. The pipe assembly 16 may include a lower pipe 22 extending through an access hole 24 in a center or approximate center of a foundation slab 26 of the structure 12 so as to be in communication with a soil 28 beneath the structure 12. The pipe assembly 16 may further include an upper pipe 30 connecting the lower pipe 22 to an exterior area outside of the structure 12. The pipe assembly 16 may further include, as desired or necessary, one or more additional intermediate pipes (not shown) connecting the lower pipe 22 to the upper pipe 30. It will be appreciated that locating and/or accessing the center of the slab 26 may not be practical for areas with complex geometries and/or intervening mechanicals or substructures, so the “approximate” center of the slab 26 refers to an area within approximately twenty percent (20%), or within five percent (5%), of the actual center. Substantially any suitable types of pipe may be used for the pipes 22,30 of the pipe assembly 16, such as PVC pipes.

The test hole 18 may be located spaced apart from the access hole 24, and may also extend through the slab 26. In one implementation, the test hole 18 may be located spaced as far apart as practically possible from the access hole 24. The proper fan 20 may be installed in substantially any suitable location along the pipe assembly 16, such as between the lower pipe 22 and the upper pipe 30. The proper fan 20 may be an inline fan, and the proper fan 20 may be a single speed fan operable to run at one speed, or it may be a multi-speed fan operable to run at multiple speeds.

The air flow system 10 may be configured to depressurize the slab 26 of the structure 12 so as to draw any radon gas 14 into the lower pipe 22 and through the upper pipe 30 so it can be vented to the exterior area. Depressurization involves creating a required negative pressure which is a function of several factors of the overall system, such as the condition of the soil 28 beneath the slab 26 and the size of the structure 12.

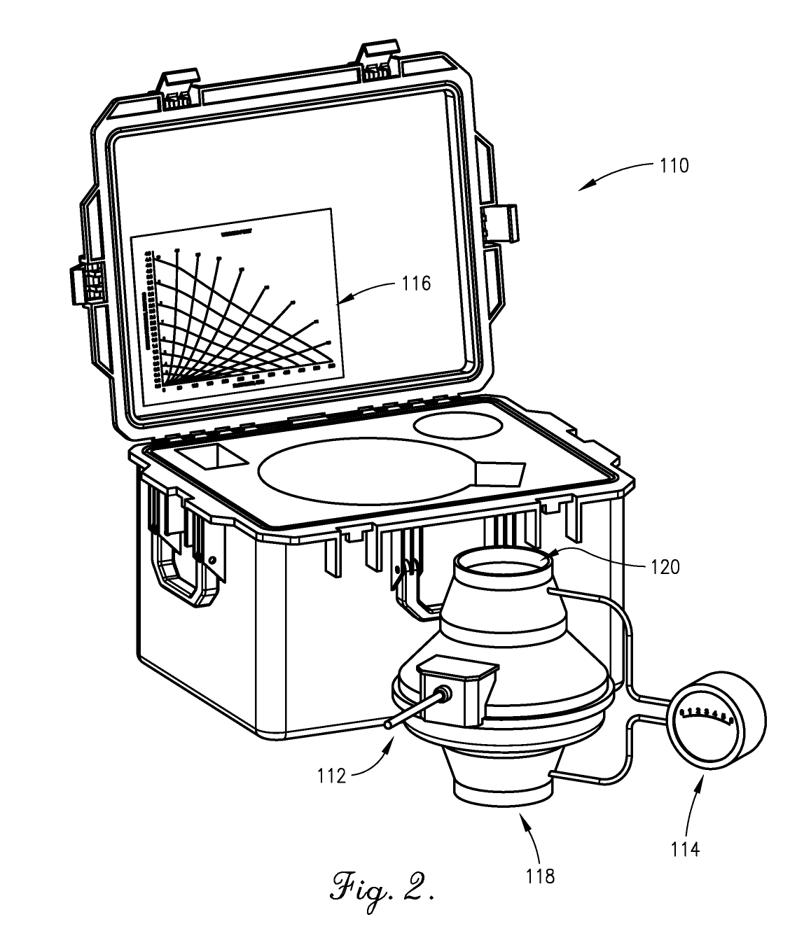

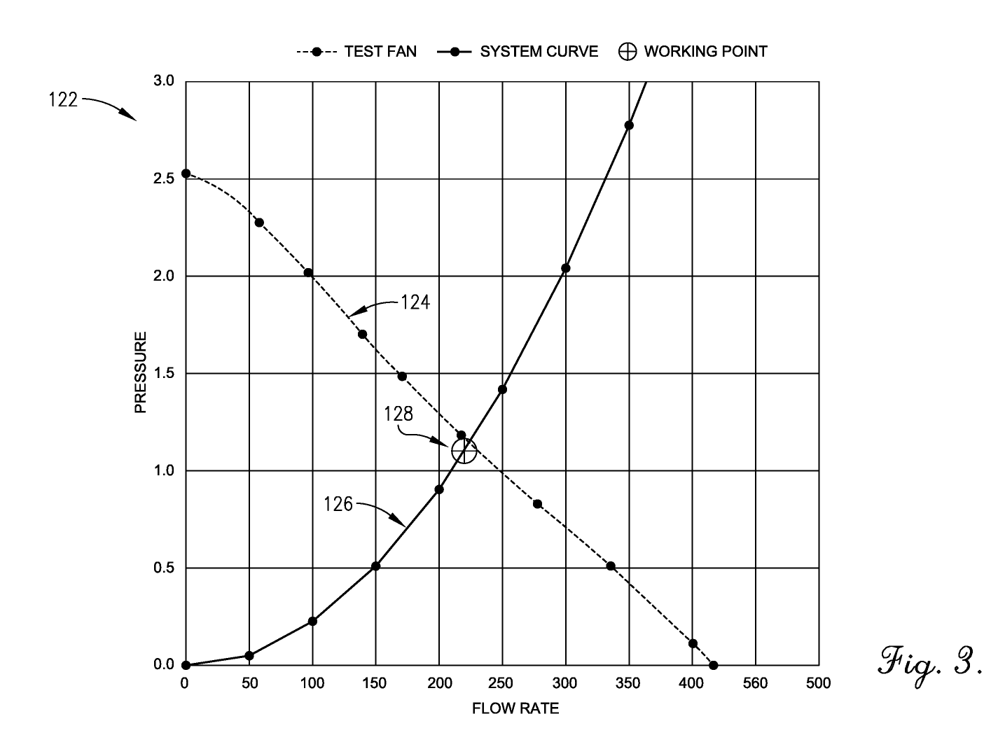

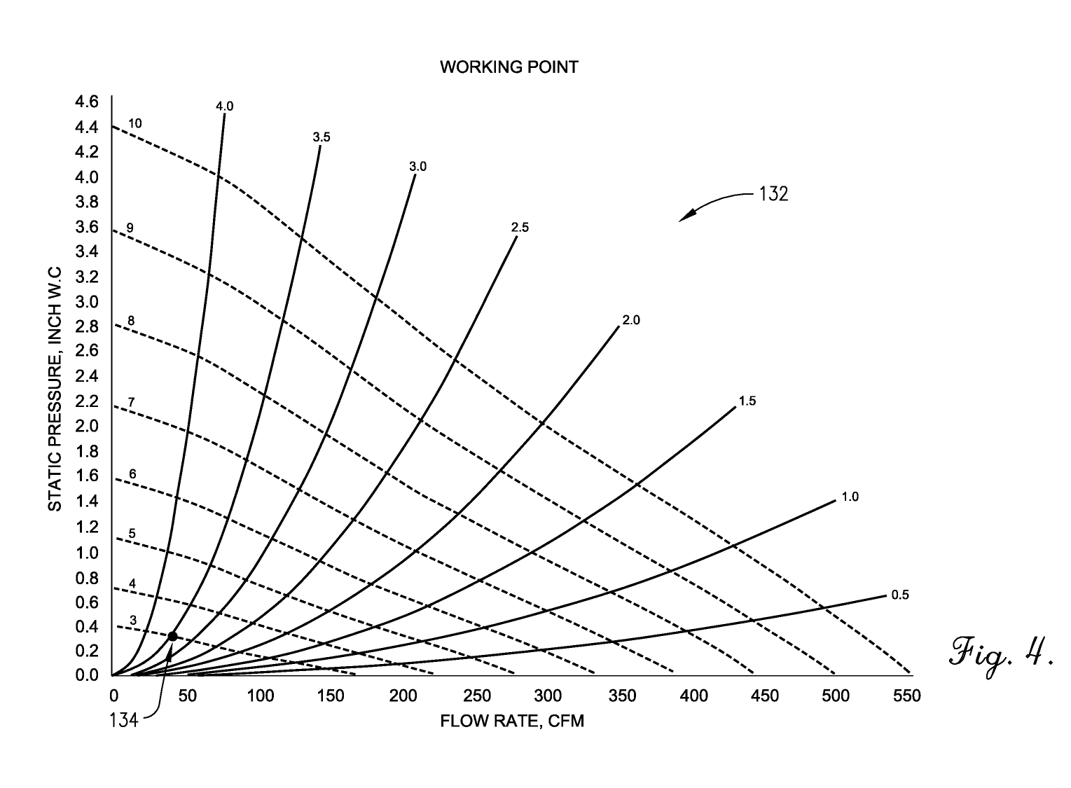

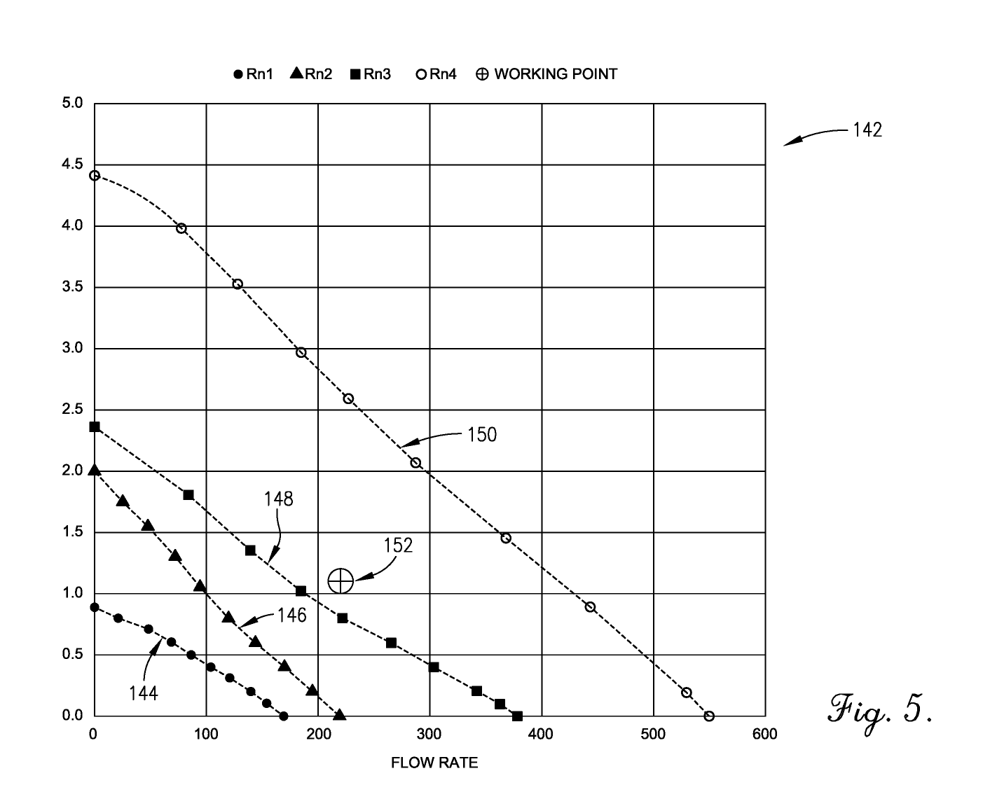

Referring to FIG. 2, an embodiment of a system 110 is shown for selecting the proper fan 20 for the air flow system 10 of FIG. 1. The system 110 may include a test fan 112, a manometer 114, and one or more charts 116 and/or a computer program. The test fan 112 may be a variable speed fan operable to run at any speed between zero and maximum. The test fan 112 may be configured to be temporarily installed in the pipe assembly 16 in the same location at which the proper fan 20 is ultimately installed. Although shown as being installed between the lower pipe 22 and the upper pipe 30, the test fan 112 and, ultimately, the proper fan 20 may be installed in substantially any suitable location along the pipe assembly 16. The manometer 114 may be configured to measure a pressure differential across the test fan 112 (i.e., between an inlet 118 and an outlet 120 of the test fan 112). The one or more charts 116 may include a working point chart (shown in FIGS. 3 and 4) and a fan selection chart (shown in FIG. 5), and may be configured for manually selecting and/or the computer program may be configured for automatically selecting the proper fan 20 based on information obtained using the test fan 112 and the manometer 114.

FIG. 3 is a first example working point chart 122 of static pressure versus flow rate showing the behavior of the test fan 112 at maximum speed and the behavior of the overall system (i.e., the combined effects of the air flow system 10, the structure 12, and the soil 28) when the test fan 112 is operating at maximum speed, and which can be used to determine a working point which can be used to identify the proper fan 20. More specifically, with the test fan 112 operating at maximum speed, the pressure drop across the test fan 112 (i.e., between the inlet 118 and the outlet 120) can be measured using the manometer 114 and the curve for the overall system can be calculated. The change in air flow is a function of the change in fan speed ratio, assuming laminar flow condition, which is known as the First Fan Law. Similarly, for a given overall system, the change in pressure drop is a function of the change in air flow ratio squared, assuming laminar flow condition, which is known as the Second Fan Law.

In FIG. 3, the downwardly sloping dotted line 124 represents the performance behavior of the test fan 112 operating at maximum speed as measured in a laboratory. The higher the static vacuum pressure, the lower the air flow rate that the test fan 112 can create. Some implementations may be more concerned with static pressure than with air flow rate. The upwardly sloping solid line 126 represents the behavior of the overall system in terms of static pressure based on the pressure differential across the test fan 112 as measured by the manometer 114. A working point 128 can be plotted on this chart.

Once the performance behavior of the test fan 112 at maximum speed is determined experimentally, the performance behavior at other speeds (e.g., at 10% intervals) can be calculated using the First Fan Law. Similarly, once the behavior of the overall system at maximum speed is determined experimentally, the behavior of the overall system at other speeds can be calculated using the Second Fan Law.

FIG. 4 is a second example working point chart 132 of static pressure versus flow rate showing the behavior of the test fan 112 operating at different speeds (in this chart, at ten (10) percent increments of maximum speed) and the behavior of the overall system at the different speeds, which can also be used to plot a working point 134 (note that this working point 134 is for a different job than the working point 128 of FIG. 3).

FIG. 5 is an example fan selection chart 142 showing static pressure versus flow rate for several different fans. In one embodiment of this chart 142, each line 144,146,148,150 may represent a different available fan, and each available fan may be a single speed fan operable to run at one speed. In another embodiment of this chart 142, two or more of the lines 144,146,148,150 may represent a single available fan which is operable to run at two or more speeds. The example fan selection chart 142 may be used to select the proper fan based on a working point 152 determined from the first or second example working point charts 122,132 or similar charts or tables. The different available fans represented on the example fan selection chart 142 may be manufactured by one manufacturer or by two or more manufacturers. In one implementation, multiple fan selection charts may be provided, with each chart presenting the available fans of a different manufacturer. The charts may be provided for manually determining the proper fan from the available fans, but it will be understood that the same information may be used by the computer program to automatically determine the proper fan.

In one implementation, the airflow system 10 may be considered distinct from the system 110, while in another implementation, the airflow system 10 may be considered part of or an extension of the system 10.

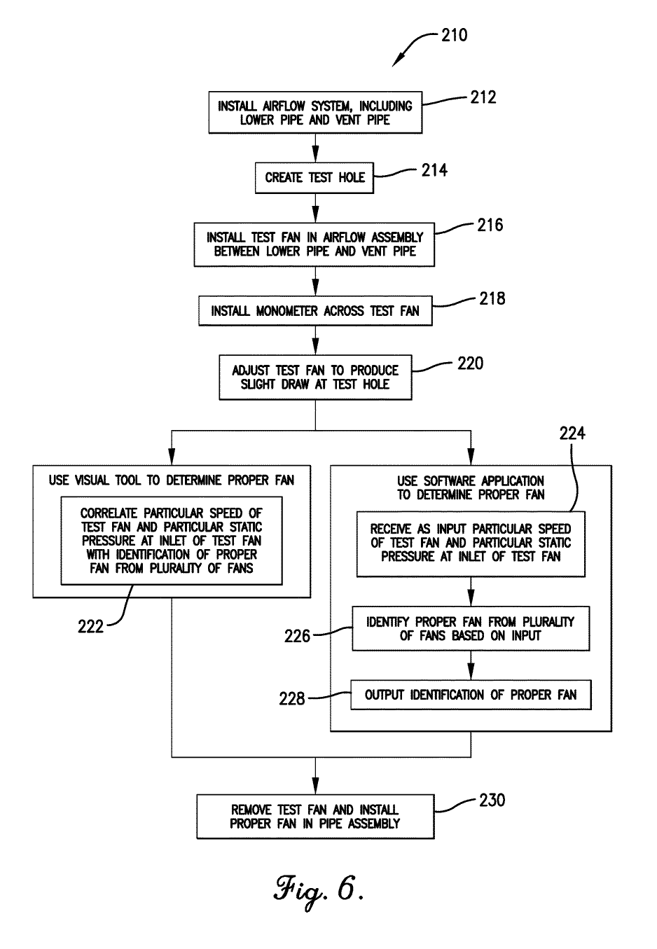

Referring to FIG. 6, the system may function substantially as follows to facilitate selection of the proper fan 20 for mitigating radon in the exemplary particular structure 12. The air flow system 10 may be installed or may already be installed including the pipe assembly 16, as shown in 212. The test hole 18 may be created extending through the slab 26, as shown in 214. The test fan 112 may be installed in the pipe assembly 16, as shown in 216, wherein the test fan 112 is a variable speed fan having a known performance curve. The manometer 114 may be installed, as shown in 218, wherein the manometer is configured to measure a static pressure value as a pressure differential across the test fan 112.

The speed of the test fan 112 may be adjusted until there is only initial communication between the test fan 112 and the test hole 18 (i.e., an initial draw at the test hole 18 due to negative pressure under the slab 26), as shown in 220. As used herein, “initial communication” and “initial draw” shall mean a measurable or otherwise detectable and consistent air flow at the test hole 18 (e.g., a negative pressure of at least two one-hundredths of an inch (−0.02″) water column. Although higher negative pressure is permissible, it may be desirable to avoid “overpowering” the motor, and only a noticeable flow is required. The corresponding particular speed of the test fan 112 at which this initial communication occurs, and the corresponding particular static pressure value of the overall system measured with the manometer 114 as the pressure differential across the test fan 112, may be noted.

In a chart implementation, a visual tool, such as the charts 122,132,142 or corresponding tables, may be configured to correlate the particular speed of the test fan 112 and the particular static pressure value of the overall system with an identification of a proper fan 20 from among a plurality of available fans, as shown in 222, wherein the proper fan 20 has an operating speed which is closest to (and preferably without being under) the particular speed. In an additional or alternative computer program implementation, a computer program may be executed on a laptop, tablet, smartphone or other mobile computing device, and receive as input the particular speed of the test fan 112 and the particular static pressure value of the overall system, as shown in 224. The computer program may identify the proper fan 20 from among a plurality of available fans based on the input, as shown in 226, wherein the proper fan 20 has an operating speed which is closest to (and preferably without being under) the particular speed. The computer program may output an identification of the proper fan 20, as shown in 228. The test fan 112 may then be removed and the proper fan 20 may be installed in the pipe assembly 16 for mitigating radon in the exemplary particular structure 12, as shown in 130.

The system 10 may include more, fewer, or alternative components and/or perform more, fewer, or alternative actions, including those discussed elsewhere herein, and particularly those discussed in the following section describing the method.

Referring again to FIG. 6, an embodiment of a method 210 is shown for facilitating selection of a proper fan for mitigating radon in the exemplary particular structure 12. The method 210 may be a corollary to the functionality of the above-described system 10, and may be similarly implemented using the various components of the system 10. Broadly, the method 210 may proceed as follows. Preliminarily, the air flow system 10 may be installed or may already be installed including the pipe assembly 16, as shown in 212. The pipe assembly 16 may include the lower pipe 22 in communication with the access hole 24 extending through an approximate center of the slab 26 and into the soil 28 beneath the exemplary particular structure 12, and the upper pipe 30 connecting the lower pipe 22 to an exterior area above the exemplary particular structure 12.

The test hole 18 may be created extending through the slab 26 at a location which is spaced apart from the access hole 24, as shown in 214. The test fan 112 may be installed in the pipe assembly 16 (e.g., between the lower pipe 22 and the upper pipe 30), as shown in 216, wherein the test fan 112 is a variable speed fan having a known performance curve. The manometer 114 may be installed, as shown in 218, wherein the manometer 114 is configured to measure a static pressure value as a pressure differential across the test fan 112.

The speed of the test fan 112 may be adjusted until there is only initial communication between the test fan 112 and the test hole 18 (i.e., an initial draw at the test hole 18 due to negative pressure under the slab 26), as shown in 220. The corresponding particular speed of the test fan 112 at which this initial communication occurs, and the corresponding particular static pressure value of the overall system measured with the manometer 114 as the pressure differential across the test fan 112, may be noted. For example, the operating speed may be thirty (30) percent of the maximum speed of the test fan 112 and the static pressure may be three and one-half (3.5) inches of water column.

In a chart implementation, a visual tool, such as the charts 122,132,142 or corresponding tables, may be configured to correlate the particular speed of the test fan 112 and the particular static pressure value of the overall system with an identification of a proper fan 20 from among a plurality of available fans, as shown in 222, wherein the proper fan 20 has an operating speed which is closest to the particular speed. It may be desirable for the proper fan to have an operating speed that is equal to or greater than the particular speed. More specifically, the visual tool may include first data representing the behavior of the test fan 112 operating at different speeds, and second data representing the behavior of the overall system resulting in different static pressure values, and an intersection of the first data and the second data may determine a working point or provide another basis for identifying the proper fan 20 from among the plurality of available fans.

In an additional or alternative computer program implementation, a computer program may be executed on a laptop, tablet, smartphone or other mobile computing device, and receive as input the particular speed of the test fan 112 and the particular static pressure value of the overall system, as shown in 224. The computer program may automatically identify the proper fan 20 from among a plurality of available fans based on the input, as shown in 226, wherein the proper fan 20 has an operating speed which is closest to (and preferably without being under) the particular speed. The computer program may output an identification of the proper fan 20, as shown in 228. The test fan 112 may then be removed and the proper fan 20 may be installed in the air flow assembly 10 for mitigating radon in the exemplary particular structure 12, as shown in 230.

The computer-implemented method 210 may include more, fewer, or alternative actions, including those discussed elsewhere herein.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for facilitating the selection of a proper fan for an air flow system for mitigating radon in a particular structure, the particular structure having—
a foundation slab,
the air flow system including—
a lower pipe in communication with an access hole extending through an approximate center of the foundation slab and into a soil beneath the foundation slab,
an upper pipe connecting the lower pipe to an exterior area above the particular structure, with the upper and lower pipes cooperatively defining a pipe assembly, and
a test hole extending through the foundation slab at a location which is spaced apart from the access hole,
the system comprising:
a test fan installed along the pipe assembly, wherein the test fan is a variable speed fan having a known performance curve;
a manometer configured to measure a static pressure value as a pressure differential across the test fan; and
a visual tool configured to correlate a particular speed of the test fan and a particular static pressure value when operation of the test fan creates an initial draw of air due to a negative pressure under the foundation slab at the test hole with an identification of a proper fan from among a plurality of possible fans, wherein the proper fan has an operating speed which is closest to the particular speed, and wherein the proper fan is to be installed in place of the test fan in the air flow system for mitigating radon in the particular structure.

2. The system of claim 1, wherein the visual tool includes—
first data representing behavior of the test fan operating at different speeds, and
second data representing behavior of an overall system resulting in different static pressure values,
wherein an intersection of the first data and the second data provides a basis for identifying the proper fan from among the plurality of possible fans.

3. The system of claim 2, wherein the visual tool is a chart, and the first data is presented as a first plotted line, and the second data is presented as a second plotted line.

4. The system of claim 1, wherein the proper fan is operable to run only at the operating speed.

5. The system of claim 1, wherein proper fan is operable to run at two or more speeds including the operating speed.

6. The system of claim 1, further including a computer program executed on a mobile computing device and configured to—
receive as input the particular speed of the test fan and the particular static pressure when operation of the test fan creates the initial draw of air due to negative pressure under the foundation slab at the test hole,
identify the proper fan from among the plurality of possible fans based on the input, wherein the proper fan has the operating speed which is closest to the particular speed, and
output the identification of the proper fan to be installed in place of the test fan in the air flow system for mitigating radon in the particular structure.

7. The system of claim 6, wherein the mobile computing device is a mobile laptop or tablet computer.

8. The system of claim 6, wherein the mobile computing device is a smartphone.

9. A system for facilitating the selection of a proper fan for mitigating radon in a particular structure having a foundation slab, the system comprising:
an air flow system including—
a lower pipe in communication with an access hole extending through an approximate center of the foundation slab and into a soil beneath the structure,
a upper pipe connecting the lower pipe to an exterior area above the particular structure, with the upper and lower pipes cooperatively defining a pipe assembly, and
a test hole extending through the foundation slab at a location which is spaced apart from the access hole;
a test fan installed along the pipe assembly, wherein the test fan is a variable speed fan having a known performance curve;
a manometer configured to measure a static pressure value as a pressure differential across the test fan; and
a computer program executed on a mobile computing device and configured to—
receive as input a particular speed of the test fan and a particular static pressure value when operation of the test fan creates an initial draw of air due to negative pressure under the foundation slab at the test hole,
identify a proper fan from among a plurality of possible fans based on the input, wherein the proper fan has an operating speed which is closest to the particular speed, and
output an identification of the proper fan to be installed in place of the test fan in the air flow system for mitigating radon in the particular structure.

10. The system of claim 9, wherein the mobile computing device is a mobile laptop or tablet computer.

11. The system of claim 9, wherein the mobile computing device is a smartphone.

12. A method for facilitating the selection of a proper fan for mitigating radon in a particular structure having a foundation slab, the system comprising:
installing an air flow system including a pipe assembly including—
a lower pipe in communication with an access hole extending through an approximate center of the foundation slab and into a soil beneath the structure, and
a upper pipe connecting the lower pipe to an exterior area above the particular structure,
wherein the upper and lower pipes cooperatively defining a pipe assembly;
creating a test hole extending through the foundation slab at a location which is spaced apart from the access hole;
installing a test fan along the pipe assembly, wherein the test fan is a variable speed fan having a known performance curve;
installing a manometer configured to measure a static pressure value as a pressure differential across the test fan;
using a computer program executed on a mobile computing device and configured to—
receive as input a particular speed of the test fan and a particular static pressure value when operation of the test fan creates an initial draw of air due to negative pressure under the foundation slab at the test hole,
identify a proper fan from among a plurality of possible fans based on the input, wherein the proper fan has an operating speed which is closest to the particular speed, and
output an identification of the proper fan; and
removing the test fan and installing the proper fan in the pipe assembly for mitigating radon in the particular structure.

13. The method of claim 12, wherein the mobile computing device is a mobile laptop or tablet computer.

14. The method of claim 12, wherein the mobile computing device is a smartphone.

15. The method of claim 12, wherein the proper fan is operable to run only at the operating speed.

16. The method of claim 12, wherein the proper fan is operable to run at two or more speeds including the operating speed.
